(19) United States
(12) Patent Application Publication
(10) Pub. No.: US 2013/0141456 A1
(43) Pub. Date: Jun. 6, 2013

(54) AUTOMATIC MODIFICATION OF IMAGE CONTENT FOR DISPLAY ON A DIFFERENT DEVICE

(71) Applicants: Igor Sokolov, Tver (RU); Andrey N. Nikankin, Sankt-Petersburg (RU); Vladimir Vasilev, Sankt-Petersburg (RU); Vsevolod Kuznetsov, Sankt-Petersburg (RU)

(72) Inventors: Igor Sokolov, Tver (RU); Andrey N. Nikankin, Sankt-Petersburg (RU); Vladimir Vasilev, Sankt-Petersburg (RU); Vsevolod Kuznetsov, Sankt-Petersburg (RU)

(73) Assignee: RAWLLIN INTERNATIONAL INC.

(21) Appl. No.: 13/311,014

(22) Filed: Dec. 5, 2011

(51) Int. Cl. G09G 5/00

(52) U.S. Cl. 345/620; 345/619

(57) ABSTRACT

Techniques for automatic modification of an image for display on a different device are presented. A content management component can analyze image content associated with a first image display frame, wherein the image content can be displayed in the first image display frame in accordance with a first subset of display characteristics of a first display. In relation to displaying the image content within a second image display frame on a second display, the content management component can automatically or dynamically modify the image content for display in the second image display frame on the second display so that the image content is displayed in the second image display frame to at least substantially correspond to the display of the image content in the first image display frame, in accordance with a second subset of display characteristics of the second display.

### TECHNICAL FIELD

This disclosure relates generally to data processing, and more specifically to automatic modification of image content for display on a different device.

### BACKGROUND

Users often include image content, such as an avatar, on social network sites, in messages (e.g., emails, text messages, instant messages, etc.), on blogs, etc. When a user uploads or sends image content, the user sometimes is requested to adjust image characteristics, such as the portion of the uploaded image to be displayed within the image display frame when the image content is presented (e.g., displayed) on the site, message, blog, etc. For example, while using a computer, the user may re-size, adjust the height, adjust the width, center an image, or take other actions, so that the image content is displayed within the image display frame in accordance with the user's specifications. The image can be displayed on the user's computer display in accordance with the user's specifications.

However, another device (e.g., communication and/or computing devices, such as mobile phones, electronic tablets, etc.), when accessing the site or blog, or when receiving a message from the user, containing the image content of the user, may display the user's image content differently than as specified by the user due to display characteristics (e.g., display screen size or shape, resolution, etc.) unique to the other device. For example, if the user's specification had the user's face centered in the image display frame so that the user's entire head is displayed in the image display frame while on the user's computer, due to the unique display characteristics of the other device, the other device may display the user's image content in the image display frame with part or all of the user's head cropped out of the image display frame.

Today, there is no way to effectively ensure that image content is displayed as desired across different types of devices. The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

The following presents a simplified summary of various aspects of the disclosed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed subject matter in a simplified form as a prelude to the more detailed description that is presented later.

In accordance with various aspects, the disclosed subject matter can include a system that can comprise a communication device configured to display content. The system also can include a content management component associated with the communication device and configured to control modification of the content to generate modified content in accordance with a subset of display characteristics associated with the communication device, wherein the content was previously formatted for display on an other communication device in accordance with an other subset of display characteristics.

In accordance with various other aspects, the disclosed subject matter can include a method comprising: employing at least one processor to facilitate execution of code instructions retained in at least one memory, the code instructions, in response to execution, perform acts comprising: analyzing information associated with image content and a subset of display characteristics associated with a communication device to generate analysis results that facilitate modifying the image content; and controlling modifying the image content to generate modified image content in accordance with the subset of display characteristics, wherein the image content has been previously formatted for display on an other communication device in accordance with an other subset of display characteristics.

In accordance with a further aspect, the disclosed subject matter can comprise a computer program product comprising a computer readable storage medium having computer executable instructions stored thereon that, in response to execution, cause a computing system to perform operations, comprising: analyzing information associated with content and a subset of display characteristics associated with a communication device to generate analysis results that facilitate modifying the content; and managing modifying the content to generate modified content in accordance with the subset of display characteristics, wherein the content has been previously formatted for display on an other communication device in accordance with an other subset of display characteristics.

The following description and the annexed drawings set forth in detail certain illustrative aspects of the disclosed subject matter. These aspects are indicative, however, of but a few of the various ways in which the principles of the disclosed subject matter may be employed. The disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example system that can manage presentation of image content on devices in accordance with various aspects and embodiments described herein.

FIG. 2 depicts a diagram of an example adjustment operation of the content management component to adjust the size of image content for a corresponding display of the image content across different display components of different communication devices, in accordance with various aspects and embodiments of the disclosed subject matter.

FIG. 3 illustrates a diagram of an example adjustment operation of the content management component to adjust the image content to crop the image content for a corresponding display of the image content across different display components of different communication devices, in accordance with various aspects and embodiments of the disclosed subject matter.

FIG. 4 presents a block diagram of another example system that can manage presentation of image content across various devices in accordance with various aspects and embodiments described herein.

FIG. 5 illustrates a block diagram of still another example system that can manage presentation of image content across various devices in accordance with various aspects and embodiments described herein.

FIG. 6 depicts a block diagram of an example content management component in accordance with various aspects and embodiments of the disclosed subject matter.

FIG. 7 illustrates is a flow chart of an example method for controlling modification of image content based at least in part on display characteristics of a communication device, in accordance with various aspects and embodiments.

FIG. 8 depicts a flow chart of another example a method for controlling modification of image content based at least in part on display characteristics of a communication device, in accordance with various aspects and embodiments.

FIG. 9 is a diagram of an example wireless communication device in accordance with various aspects and embodiments of the disclosed subject matter.

FIG. 10 is a schematic block diagram illustrating a suitable operating environment.

FIG. 11 is a schematic block diagram of a sample-computing environment.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Image content, such as avatars, is often used in relation to web sites (e.g., social networking web sites), blogs, messages, etc. A user typically can upload the user's image content and adjust it (e.g., re-size, crop, or otherwise modify the image) so that the image content is displayed as desired by the user when viewed on the display of the user's device (e.g., computer). However, when that image content is viewed on other devices (e.g., display screen of a mobile phone, an electronic tablet, etc.) the image content may display differently or incorrectly as compared to how that image content is displayed on the user's device. For example, on other devices, the image content can be cropped or re-sized differently and/or in an otherwise undesirable manner (e.g., oddly), as compared to how that image content is displayed on the user's device. Today, there is no way to effectively ensure that image content is displayed as desired across different types of devices.

Techniques for automatic modification of an image for display on a different device are presented. A content management component can analyze image content associated with a first image display frame, wherein the image content can be displayed in the first image display frame in accordance with a first subset of display characteristics of a first display. In relation to displaying the image content within a second image display frame on a second display, the content management component can automatically or dynamically modify the image content for display in the second image display frame on the second display so that the image content is displayed in the second image display frame to at least substantially correspond to the display of the image content in the first image display frame, in accordance with a second subset of display characteristics of the second display.

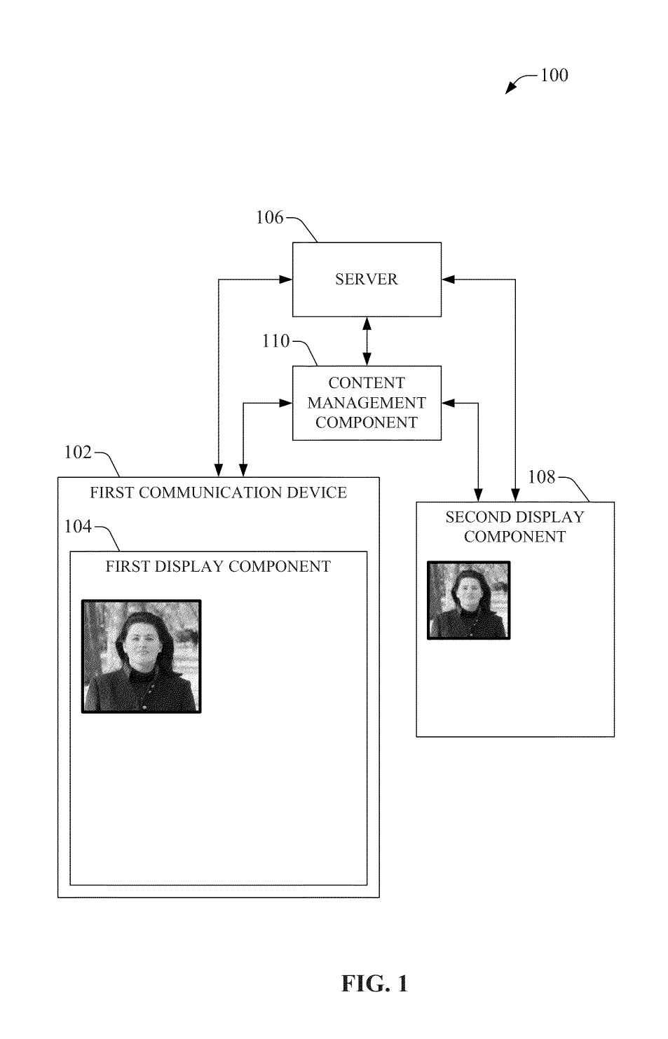

Referring now to the drawings, FIG. 1 illustrates a block diagram of an example system 100 that can manage presentation of image content on devices in accordance with various aspects and embodiments described herein. In an aspect, the system 100 can include a first communication device 102 (e.g., computer), which can be associated with a user, and can be used by the user to, for example, access web sites (e.g., social networking web sites, news web sites, etc.) or blogs, send or receive messages (e.g., emails, instant messages, text messages, etc.), etc. The first communication device 102 can include or be associated with a first display component 104 that can present (e.g., display) information (e.g., text, image content, video content, etc.) to the user. The first display component 104 can comprise a first subset of display characteristics, such as a first display resolution, a first display screen size, a first display screen shape, etc., which can determine, at least in part, how the information will appear or be perceived when displayed on the first display component 104.

The user can use the first communication device 102 to upload or send image content (e.g., an avatar and/or a profile picture, or other image) for presentation to other users via other communication devices. For example, the user can use the first communication device 102 to upload image content (e.g., to a server, such as server 106) to be displayed on the user's social networking page for viewing by other users via other communication devices (e.g., mobile communication device, electronic tablet, Internet Protocol television (IPTV), computer, electronic gaming device, personal digital assistant (PDA), a set-top box, an electronic notebook, etc.). As another example, the user can use the first communication device 102 to send (e.g., transmit) a message, which includes image content within the message, to a communication device of another user. As still another example, the user can use the first communication device 102 to communicate (e.g., transmit or post) a comment on a blog or social networking web site, wherein image content (e.g., avatar and/or profile picture) can be associated with (e.g., displayed in proximity to) the comment.

In some implementations, the system 100 can include a server 106 that can be associated with (e.g., communicatively connected, via a wireline or wireless communication connection, to) the first communication device 102, wherein information, such as image content, textual information, etc., can be communicated between the first communication device 102 and the server 106. In accordance with various embodiments, the server 106 can be associated with a web site (e.g., social networking web site) and/or can be a message server, a news server, a video server, an electronic gaming server, or other type of server.

When the user uses the first communication device 102 to upload or send image content to or via the server 106, the image content can be displayed to the user on the first display component 104 (e.g., after uploading the image content, or when preparing to send the image content) based at least in part on the first subset of display characteristics of the first display component 104. For instance, when the image content is uploaded to the server 106, the user can or may be able to adjust (e.g., re-size the image content, crop the image content, etc.) the display of the image content on the first display component 104 using the first communication device 102 (e.g., interface component of the first communication device 102), wherein the user's frame of reference with regard to the display of the image content can be based on the user's viewing of the image content on the first display component 104 in accordance with the first subset of display characteristics. For example, the user, using the first communication device 102, may adjust the display of the image content within an image display frame (e.g., usable for displaying an avatar and/or a profile picture, etc.) as displayed on the first display component 104 by sending adjustment control information to the server 106.

In response to receiving the adjustment control information, the server 106 can adjust the display of the image content within the image display frame in accordance with the adjustment control information. As a result, the first display component 104 can display the image content within the image display frame to the user, based at least in part on the first subset of display characteristics and the user's specification for display (e.g., in accordance with the adjustment control information provided by the user). In some implementations, the server 106 also can adjust the display and/or formatting of the image content based at least in part on predefined display criterion applicable at the server side. Display characteristics (e.g., first subset of display characteristics and/or display characteristics associated with current display of the image content) associated with the image content can be mapped to (e.g., linked to) and/or stored with the image content, and can be available for use to facilitate making determinations regarding modifying the image content for display on other display components (e.g., a second display component 108), as more fully disclosed herein.

However, other displays on other devices can have different display characteristics than the first subset of display characteristics associated with the first display component 104. As a result, the image content (e.g., as displayed within the image display frame) can be displayed differently and/or undesirably on another display. For example, the image content may be displayed on another display component of another device such that the image content is cropped or sized differently than the image content is displayed on the first display component 104 due in part to the different display characteristics of the other display component of the other device.

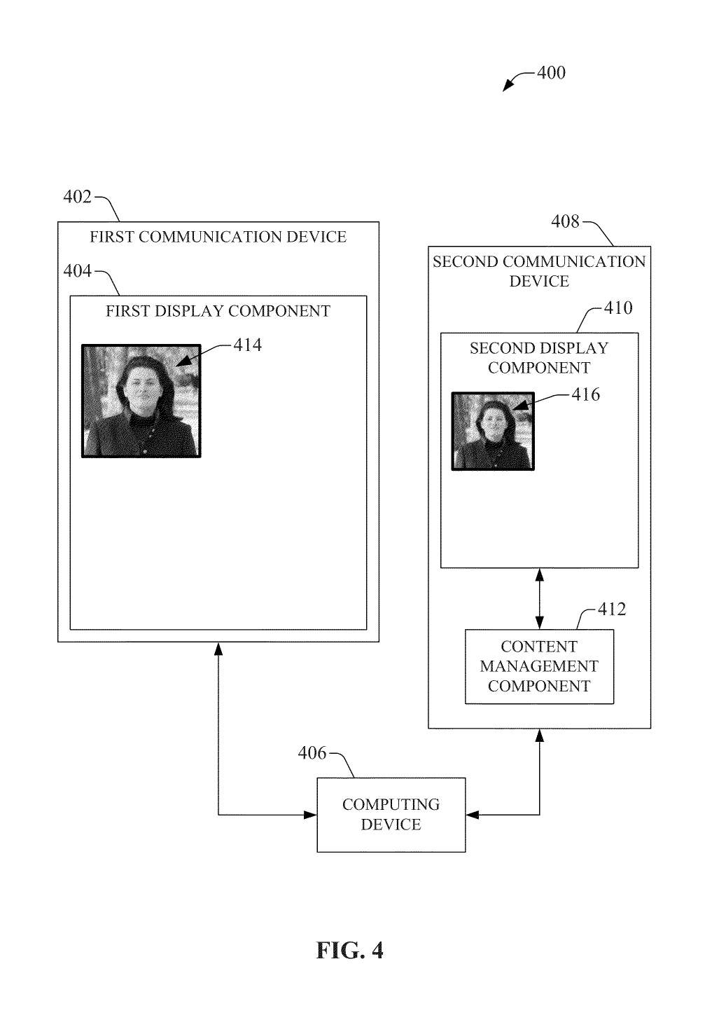

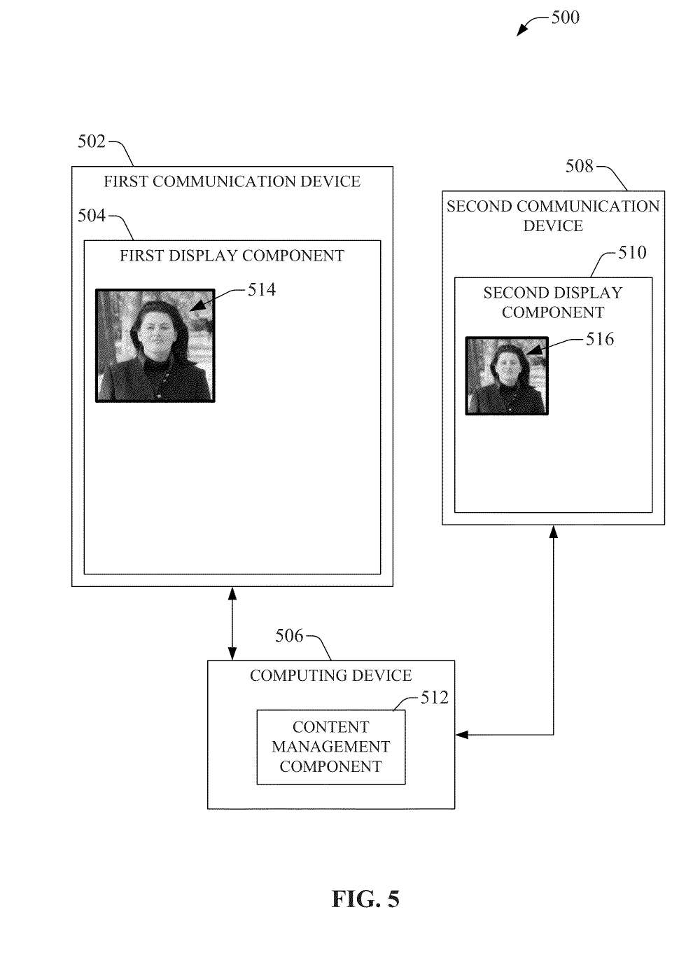

In accordance with some aspects, the system 100 can include a second display component 108 (e.g., associated with a second communication device (not shown in FIG. 1; e.g., as depicted in FIGS. 4 and 5)) that can display information (e.g., textual information, image content, etc.) in accordance with a second subset of display characteristics, which can be different from the first subset of display characteristics, and which can determine, at least in part, how the information will appear or be perceived when displayed on the second display component 108. As a result, the image content associated with the user may be displayed differently and/or undesirably (e.g., as undesired by the user) on the second display component 108. For example, the second display component 108 can be associated with a mobile communication device (e.g., mobile phone) that can have a smaller sized display screen or differently shaped display screen (e.g., as compared to the first display component 104) that, unless the image content is adjusted, can alter the display of the image content on the second display component 108 as compared to the display of the image content on the first display component 104.

In accordance with some implementations, the system 100 can include a content management component 110 that can be associated with the first communication device 102, the server 106, and/or the second display component 108, and can automatically and/or dynamically control generation, modification and/or display of image content so that the image content can be displayed so that the image content can be perceived to be the same or substantially the same across different communication devices, in accordance with predefined display criterion. The content management component 110 can thereby facilitate uniform or substantially uniform display of content across different display components having different display characteristics.

For instance, even though the second display component 108 has a second subset of display characteristics that are different than the first subset of display characteristics of the first display component 104, the content management component 110 can automatically and/or dynamically control display of the image content associated with the user of the first communication device 102 to modify the image content so that such modified image content is displayed on the second display component 108 to look the same as, or substantially the same as, the image content when the image content is displayed on the first display component 104. In accordance with various aspects, when the image content associated with the user is to be displayed on the second display component 108, the content management component 110 can modify (e.g., automatically and/or dynamically) display parameters associated with the image content to adjust the size, crop, adjust display resolution, adjust the orientation, etc., the image content to generate modified image content, in accordance with the second subset of display characteristics, so that the modified image content is displayed on the second display component 108 so that when the modified image content is viewed on the second display component 108 the modified image content (e.g., within an image display frame) appears to look the same, or at least substantially the same as, the original image content (e.g., within an image display frame) appears when viewed on the first display component 104 (e.g., in accordance with the first subset of display characteristics).

In some implementations, the content management component 110 can analyze image content and can identify the contour(s) (e.g., shape, form, etc.), feature(s), size(s), etc., of an object(s) (e.g., face, shoulders, or other body features, of the user) contained in the image content. The content management component 110 also can analyze the first subset of display characteristics, current display characteristics (e.g., which may include all or a portion of the first subset of display characteristics), and/or the second subset of display characteristics. The content management component 110, applying one or more predefined display criterion (or applying corresponding predefined display rules), can generate analysis results based at least in part the analysis of the image content, the first subset of display characteristics, current display characteristics, and the second subset of display characteristics. Based at least in part on the analysis results, the content management component 110 can modify the display of the image content, e.g., on the second display component 108, to re-size, crop, or otherwise adjust the display of, the image content on the second display component 108 to correspond, or at least substantially correspond, with the display of the image content on the first display component 104.

For example, the content management component 110 can identify differences between the second subset of display characteristics and the first subset of display characteristics and/or current display characteristics. Based at least in part on the identified differences in display characteristics, the content management component 110 can modify the display of the image content on the second display component 108 to compensate or account for the differences between the second subset of display characteristics and the first subset of display characteristics and/or current display characteristics, so that the image content is displayed on the second display component 108 to look the same or substantially the same as when the image content is displayed on the first display component 104.

In certain implementations, the content management component 110 can transmit a query to the server 106 to obtain information (e.g., display size information, cropping information, resolution information, information relating to the first display component 104, user specifications, etc., relating to the first subset of display characteristics and/or current display characteristics) relating to the displaying of the image content, for example, within an image display frame. In response, the server 106 can provide the requested information. The content management component 110 can analyze such information and the second subset of display characteristics to generate analysis results, based at least in part on the predefined display criterion. Based at least in part on those analysis results, the content management component 110 can modify the display of the image content on the second display component 108 so that the modified image content can correspond, or at least substantially correspond, with the display of the image content on the first display component 104.

In accordance with some embodiments, the content management component 110 can generate, maintain, and/or modify a Cascading Style Sheets (CSS) file for each communication device (e.g., second communication device associated with the second display component 108) and/or for each type of communication device, and/or a dynamic CSS collection for various communication device attributes (e.g., display characteristics), e.g., screen resolution, screen size, content positioning, etc. In some implementations, the content management component 110 can be part of or associated with (e.g., communicatively connected to) a cloud (not shown). The content management component 110 can store all or a portion of the CSS parameters (e.g., settings) of a CSS collection(s) or file(s), in relation to presentation of images and/or other content for each communication device, in the cloud. Various services can access the information in the CSS collection(s) or file(s) from the cloud (e.g., content management component 110 associated with the cloud) to facilitate formatting or modifying content for presentation on respective communication devices (e.g., second communication device associated with the second display component 108).

When formatting or modifying content (e.g., image, text, object, etc.) for presentation on a particular communication device, a service can transmit, to the cloud (e.g., content management component 110 associated with the cloud), a request for information from a CSS collection or file that is relevant to the particular communication device. The content management component 110 can identify information in a CSS collection or file responsive to the request, can retrieve such identified information from the CSS collection or file, and can transmit such identified information to the service, wherein, for example, such identified information can include information specifying communication-device specific layout, design or formatting information, and/or other display-characteristic-related information. The service can include a local content management component (e.g., comprising same or similar functionality as the content management component 110) that can process (e.g., format, center an object in a display frame, re-size, crop, re-orient, etc.) the content in accordance with the received information from the CSS collection or file.

In such instances involving a CSS collection or file in a cloud, for example, content-design-and-layout developers can be relieved from the necessity of having to design in relation to content presentation for each communication device separately, and can instead include a reference to such cloud-based CSS collection(s) or file(s), wherein the reference can enable services or other entities to know where to obtain desired information (e.g., display-characteristic information) that can be used to facilitate processing content for presentation on a communication device (e.g., second communication device associated with the second display component 108). As a result, the developers' tasks for each communication device can be resolved for them not only for images, but for any type of content.

In accordance with still other implementations, the content management component 110 can access the image content on the web site on which it is posted by the user, access the image content in the message in which the image content is contained, and/or can otherwise access information relating to the image content, and can analyze the image content, or related information, to identify the contour of the object(s), the size of the object(s), etc., within the image display frame, wherein the analysis also can take into account the second subset of display characteristics of the second display component 108. Based at least in part on this analysis, the content management component 110 can modify the display of the image content when displayed (e.g., within an image display frame) on the second display component 108, to re-size, crop, re-format, or otherwise adjust the display of the image content on the second display component 108 so the modified image content can correspond, or at least substantially correspond, with the display of the image content (e.g., within an image display frame) on the first display component 104.

In certain instances, the image content can comprise multiple images. For example, the image content can be animated image content (e.g., animated avatar or profile picture in a format, such as animated Graphics Interchange Format (GIF), Small Web Format (SWF), etc.) that can include a plurality of images (e.g., sequence of images) that typically continue cycling and repeating. For instance, a first image of the sequence can be displayed for a predefined period of time, with the first image being replaced by a second image of the sequence, wherein the second image can be displayed for the predefined period of time, and so on until each of the images in the sequence has been displayed. When the last image of the sequence of images in the animated image content is displayed, the sequence can proceed back to the first image in the sequence, and the sequence of images can continue to be displayed from that point.

In some implementations, the content management component 110 can automatically and/or dynamically control generation, modification and/or display of animated image content to so that the animated image content is displayed the same or substantially the same across different communication devices, in accordance with the predefined display criterion. The content management component 110 can thereby facilitate uniform or substantially uniform display of the animated image content across different display components (e.g., display component 104, display component 108) having different display characteristics.

The content management component can analyze each of the images in the plurality of images that make up the animated image content, display characteristics associated with the animated image content (e.g., first subset of display characteristics associated with the first display component 104 and/or current display characteristics associated with the content), the second subset of display characteristics associated with the second display component 108, and/or other information to generate analysis results that can be used to modify the images of the animated image content for display on the second display component 108, in accordance with the second subset of display characteristics. The content management component 110 also can identify the length of time each image of the animated image content is to be displayed, for example, based at least in part on display characteristics or metadata associated with the animated image content.

The content management component 110 can maintain continuity between respective images of the animated image content, based at least in part on the analysis results. In some implementations, the content management component 110 can modify the respective images of the animated image content in a same or similar manner to facilitate maintaining display continuity between the respective images. For example, the content management component 110 can re-size, re-orient, crop, re-frame, or otherwise modify display of, each of the images in the animated image content using same or similar modification parameters for each image (e.g., each image can be re-sized to reduce their size in half), in accordance with the second subset of display characteristics and predefined display criterion.

In accordance with various aspects, if, for some reason, the content management component 110 is unable to obtain or identify sufficient information from which to identify how the image content is presented for display on the first display component 104, the content management component 110 can still modify the image content, based at least in part on the second subset of display characteristics, so that the modified image content can be desirably displayed on the second display component 108. For example, if unable to identify how the image content is presented for display on the first display component 104, the content management component 110 can still analyze the image content and associated information (e.g., formatting information, metadata, etc.) and the second subset of display characteristics, can identify an object(s) in the image content, and can modify the image content to desirably display the object(s) on the second display component 108, in accordance with the second subset of display characteristics. For instance, the content management component 110 can center the object(s) in the image display frame, re-size the image so that a desired object(s) or element(s) can be desirably displayed in the image display frame, re-orient the image, and/or crop the image, etc. As a result, while the image content may or may not appear to be the same when displayed on the second display component 108 as when displayed on the first display component 104, the content management component 110 can still perform a default modification of the image content to desirably display the image content on the second display component 108, in accordance with the second subset of display characteristics and predefined display criterion.

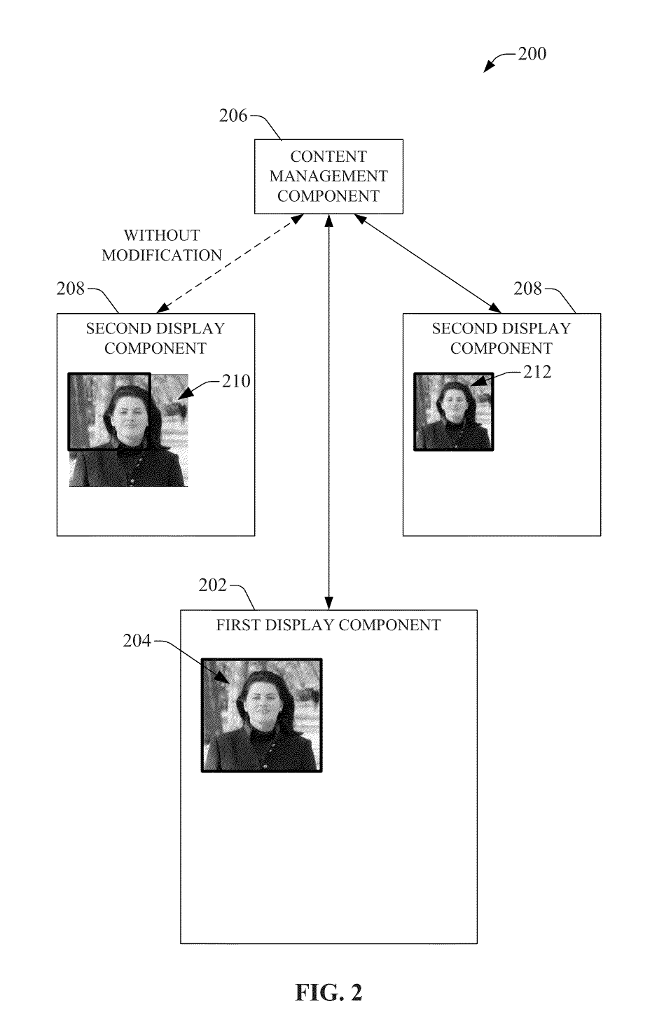

FIG. 2 depicts a diagram of an example adjustment operation 200 of the content management component to adjust the size of image content for a corresponding display of the image content across different display components of different communication devices, in accordance with various aspects and embodiments of the disclosed subject matter. The example adjustment operation 200 can include a first display component 202 that can have a first subset of display characteristics. The first display component 202 can be used to display an image 204, in accordance with the first subset of display characteristics.

The example adjustment operation 200 can include a content management component 206 that can be used to control display of image content on a second display component 208, in accordance with the predefined display criterion, as more fully disclosed herein. The second display component 208 can be associated with a second subset of display characteristics, which can be different from or the same as the first subset of display characteristics and/or current display characteristics associated with the image content (e.g., display characteristics associated with the server side).

When it is desired to display the image 204 on the second display component 208, the content management component can obtain a copy image 210 of the image 204 (e.g., from a server), wherein the copy image 210 can correspond to the image 204. In some instances, due in part to differences between the second subset of display characteristics and first subset of display characteristics (and/or current display characteristics, the copy image 210 can have a different size or other display differences if displayed on the second display component 208 without modification. In this example shown in FIG. 2, the copy image 210 is significantly larger than the display area (e.g., display screen, or image display frame within the display screen) of the second display component 208 to be used to display the copy image 210.

The content management component 206 can analyze the copy image 210 (e.g., analyze display characteristics associated with the copy image 210), the second subset of display characteristics, and/or other information. As part of the analysis, the content management component 206 can identify that the size of the copy image 210 is larger than the display area on the second display component 208 by a specified amount or scale (e.g., size factor) and/or can identify the contour of an object(s) (e.g., contour of a person's head and shoulders) in the copy image 208. The content management component 206 can modify the size and/or resolution of the copy image 210 to generate a modified image 212, based at least in part on the analysis results, the second subset of display characteristics, and the predefined display criterion.

The content management component 206 can provide (e.g., transmit) the modified image 212 to the second display component 208 for display. The second display component 208 can display the modified image 212 in the display area (e.g., image display frame) on the second display component 208, wherein the modified image 212 can be displayed on the second display component 208 so that the modified image 212 is perceived to look the same or substantially the same when displayed on the second display component 208 as the image 204 when the image 204 is displayed in the display area of the first display component 202.

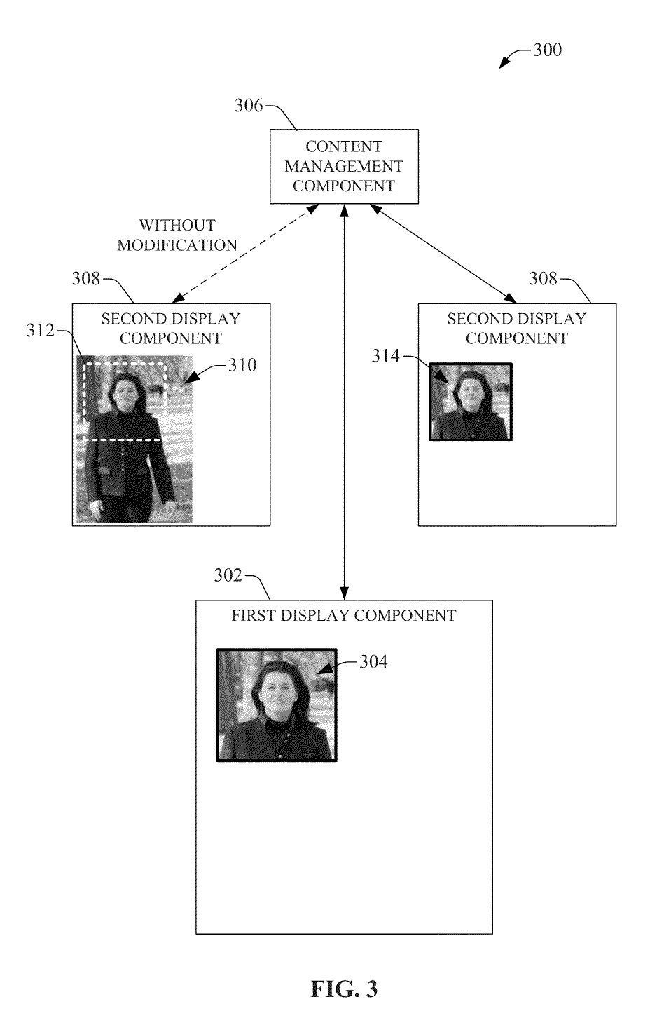

FIG. 3 illustrates a diagram of an example adjustment operation 300 of the content management component to adjust the image content to crop the image content for a corresponding display of the image content across different display components of different communication devices, in accordance with various aspects and embodiments of the disclosed subject matter. The example adjustment operation 300 can include a first display component 302 that can have a first subset of display characteristics. The first display component 302 can be used to display an image 304, in accordance with the first subset of display characteristics (and/or current display characteristics associated with the image 304, as more fully disclosed herein).

The example adjustment operation 300 can include a content management component 306 that can be used to control display of image content on a second display component 308, in accordance with the predefined display criterion, as more fully disclosed herein. The second display component 308 can be associated with a second subset of display characteristics, which can be different from or the same as the first subset of display characteristics and/or current display characteristics.

When it is desired to display the image 304 on the second display component 308, the content management component can obtain a copy image 310 of the image 304 (e.g., from a server), wherein the copy image 310 can correspond to the image 304. In some instances, due in part to differences between the second subset of display characteristics and first subset of display characteristics (and/or current display characteristics, the copy image 310 can have a different size, different shape, or other display differences if displayed on the second display component 308 without modification. In this example shown in FIG. 3, the copy image 310 depicts the full body of the person, whereas the image 204 only depicts the head and shoulders of the person.

The content management component 306 can analyze the copy image 310 (e.g., analyze display characteristics associated with the copy image 310), the second subset of display characteristics, and/or other information (e.g., first subset of display characteristics, current display characteristics, metadata or other information associated with the copy image 310 (e.g., as received from the server or as otherwise obtained by the content management component 306). As part of the analysis, the content management component 306 can identify the contour of the object (e.g., the person) in the copy image 310 and can further identify the object is a full body depiction, and can identify the contour of the object in the image 304 as depicting only the head and shoulders of the person. Based at least in part on the analysis results, the content management component 306 can modify the copy image 310, including cropping the copy image 310 such that only an image portion 312 of the head and shoulders of the person is selected by the content management component 306, to generate a modified image 314 depicting the head and shoulders of the person, in accordance with the second subset of display characteristics and the image 304 as it is displayed by the first display component 302.

The content management component 306 can provide (e.g., transmit) the modified image 314 to the second display component 308 for display. The second display component 308 can display the modified image 314 in the display area (e.g., image display frame) on the second display component 308, wherein the modified image 314 can be displayed on the second display component 308 so that the modified image 212 is perceived to look the same or substantially the same when displayed on the second display component 308 as the image 304 when the image 304 is displayed in the display area of the first display component 302.

FIG. 4 presents a block diagram of another example system 400 that can manage presentation of image content across various devices in accordance with various aspects and embodiments described herein. The system 400 can comprise a first communication device 402 (e.g., computer), which can be associated with a user, and can be used by the user to, for example, access web sites (e.g., social networking web sites, news web sites, etc.) or blogs, send or receive messages (e.g., emails, instant messages, text messages, etc.), etc. The first communication device 402 can include or be associated with a first display component 404 that can present (e.g., display) information (e.g., text, image content, video content, etc.) to the user. The first display component 404 can comprise a first subset of display characteristics, such as a first display resolution, a first display screen size, a first display screen shape, etc., which can determine, at least in part, how the information will appear or be perceived when displayed on the first display component 404.

The system 400 can include a computing device 406 (e.g., a server, a computer, or other type of computing and/or communication device) that can be associated with (e.g., communicatively connected, via a wireline or wireless communication connection, to) the first communication device 402. Information, such as image content, textual information, etc., can be communicated between the first communication device 402 and the computing device 406. In accordance with various embodiments, the computing device 406 can be associated with a web site (e.g., social networking web site, blog, etc.) and/or can be a message server, a news server, a video server, an electronic gaming server, or other type of server. When the user uses the first communication device 402 to upload or send image content to or via the computing device 406, the image content can be displayed on the first display component 404 (e.g., after uploading the image content, or when preparing to send the image content) based at least in part on the first subset of display characteristics of the first display component 404 and/or current display characteristics (e.g., based on aspects relating to the computing device 406).

The system 400 can contain a second communication device 408 (e.g., mobile phone, electronic pad or tablet, video player, or other type of communication device), that can be associated with (e.g., communicatively connected, via a wireline or wireless communication connection, to) the computing device 406. The second communication device 408 can include or be associated with a second display component 410 that can present (e.g., display) information (e.g., text, image content, video content, etc.) to one or more users. The second display component 410 can comprise a second subset of display characteristics, such as a second display resolution, a second display screen size, a second display screen shape, etc., which can determine, at least in part, how the information will appear or be perceived when displayed on the second display component 410.

In some implementations, the second communication device 408 can comprise a content management component 412 that can manage generation, modification and/or display of information (e.g., image content, textual information, etc.) on the second display component 410, in accordance with the second subset of display characteristics, as more fully disclosed herein. In accordance with the second subset of display characteristics, the content management component 412 can manage generation, modification and/or display of information associated with other devices (e.g., first communication device 402, computing device 406) to have the information displayed on the second display component 408 such that it can be perceived by a user to look the same or substantially the same as that information is perceived when displayed on a different display component (e.g., first display component 404) having different display characteristics (e.g., first subset of display characteristics and/or current display characteristics).

In certain implementations, the content management component 412 can obtain information relating to, for example, image content (e.g., metadata, current display characteristics, etc.), the first display component 404 (e.g., first subset of display characteristics), the computing device 406, etc., from sources, such as the computing device 406, to facilitate controlling generation, modification and/or display of the image content (e.g., modified image content) on the second display component 410, in accordance with the second subset of display characteristics. For example, when obtaining image content associated with the first communication device 402 (e.g., image content 414 uploaded or modified for display on the first display component 404 by the first communication device 402), the content management component 412 can query the computing device 406 to request other information (e.g., image formatting information) relating to the image content. This other information can include, for example, modifications (e.g., cropping, re-sizing, applying of visual effects, changes to orientation, framing adjustments to the image content within an image display frame, etc.) to the image content made by the computing device 406, for example, in response to modification requests or commands from the first communication device 402, another communication device (e.g., associated with a web site), or made by the computing device 406 based at least in part on display criterion associated with the computing device 406.

The content management component 412 can receive the image content and associated information from the computing device 406. The content management component 412 can analyze the image content and associated information, and the second subset of display characteristics of the second display component 412, to generate analysis results. The content management component 412 can modify the image content, based at least in part on these analysis results, to generate modified image content 416 for display in a desired display area (e.g., image display frame) of the second display component 410. The modified image content 416 can be displayed on the second display component 410 such that, when perceived on the second display component 410, the modified image content 416 can look the same or substantially the same as the image content 414 when the image content 414 is displayed on the first display component 404.

FIG. 5 illustrates a block diagram of still another example system 500 that can manage presentation of image content across various devices in accordance with various aspects and embodiments described herein. The system 500 can comprise a first communication device 502 (e.g., computer), which can be associated with a user, and can be used by the user to, for example, access web sites (e.g., social networking web sites, news web sites, etc.) or blogs, send or receive messages (e.g., emails, instant messages, text messages, etc.), etc. The first communication device 502 can include or be associated with a first display component 504 that can present (e.g., display) information (e.g., text, image content, video content, etc.) to the user. The first display component 504 can comprise a first subset of display characteristics, which can determine, at least in part, how the information will be displayed or perceived when displayed on the first display component 504.

The system 500 can include a computing device 506 (e.g., a server, a computer, or other type of computing and/or communication device) that can be associated with (e.g., communicatively connected, via a wireline or wireless communication connection, to) the first communication device 502. Information, such as image content, textual information, etc., can be communicated between the first communication device 502 and the computing device 506. In accordance with various embodiments, the computing device 506 can be associated with a web site (e.g., social networking web site, blog, etc.) and/or can be a message server, a news server, a video server, an electronic gaming server, or other type of server. When the user uses the first communication device 502 to upload or send image content to or via the computing device 506, the image content can be displayed on the first display component 504 (e.g., after uploading the image content, or when preparing to send the image content) based at least in part on the first subset of display characteristics of the first display component 504 and/or current display characteristics (e.g., which can be based at least in part on aspects relating to the computing device 506).

The system 500 can contain a second communication device 508 (e.g., mobile phone, electronic pad or tablet, video player, or other type of communication device), that can be associated with (e.g., communicatively connected, via a wireline or wireless communication connection, to) the computing device 506. The second communication device 508 can include or be associated with a second display component 510 that can present (e.g., display) information (e.g., text, image content, video content, etc.) to one or more users. The second display component 510 can comprise a second subset of display characteristics, which can determine, at least in part, how the information will be displayed or perceived when displayed on the second display component 510.

In some implementations, the computing device 506 can comprise a content management component 512 that can manage generation, modification and/or communication of information (e.g., image content, textual information, etc.) to be provided to the second communication device 508 for display on the second display component 510, in accordance with the second subset of display characteristics, as more fully disclosed herein. In accordance with the second subset of display characteristics, the content management component 512 can manage generation, modification and/or communication of information associated with other devices (e.g., first communication device 502, computing device 506) to have the information displayed on the second display component 508 such that such information can be perceived by a user to look the same or substantially the same on the second display component 510 as that information is perceived when displayed on a different display component (e.g., first display component 504) having different display characteristics (e.g., first subset of display characteristics).

In certain implementations, the content management component 512 can obtain information relating to, for example, image content 514 (e.g., metadata, display characteristics, etc., relating to image content 514) associated with the first communication device 502, the first display component 504 (e.g., first subset of display characteristics), the second display component 508 (e.g., second subset of display characteristics), the second communication device 508, the computing device 506, etc., to facilitate controlling generation or modification of the image content to generate modified image content 516 for communication to the second communication device 508 for display on the second display component 510, in accordance with the second subset of display characteristics.

For example, when the second communication device 508 is being used to obtain image content associated with the first communication device 502 (e.g., image content 514 uploaded or modified for display on the first display component 504 by the first communication device 502), the second communication device 508 can transmit a request for the image content to the computing device 506. The request can include information, such as information relating to the second subset of display characteristics, or may not include such information. In response to the request, if the request did not contain information relating to the second subset of display characteristics, the content management component 512 of the computing device 506 can transmit a query to the second communication device 508, wherein the query can request information relating to the display characteristics of the second communication device 508. In response to the query, the second communication device 508 can transmit information relating to the second subset of display characteristics to the content management component 512, which can receive such information.

The content management component 512 can analyze the image content, information including modification information (e.g., information relating to cropping, re-sizing, applying of visual effects, changes to orientation, framing adjustments to the image content within an image display frame, etc.) relating to the image content, and the second subset of characteristics, to generate analysis results. The content management component 512 can modify the image content, based at least in part on these analysis results, to generate modified image content 516 for display in a desired display area (e.g., image display frame) of the second display component 510. The modified image content 516 can be displayed on the second display component 510 such that, when perceived on the second display component 510, the modified image content 516 can look the same or substantially the same as the image content 514 when the image content 514 is displayed on the first display component 504.

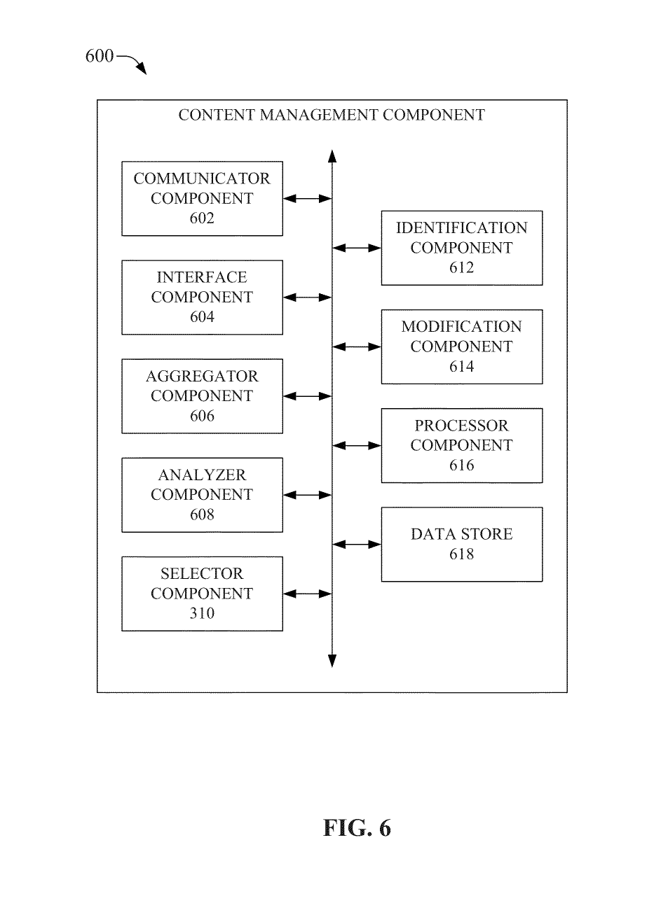

FIG. 6 depicts a block diagram of an example content management component 600 in accordance with various aspects and embodiments of the disclosed subject matter. In accordance with various aspects, the content management component 600 can comprise a communicator component 602 that can be employed to communicate (e.g., transmit, receive) information, including information relating to image content, between the content management component 600 and other components or devices (e.g., first communication device, second communication device, computing device, etc.) associated with a communication network environment. The communicator component 602 can employ one or more communication protocols to facilitate controlling data or voice flows associated with the content management component 600. The communicator component 602 also can communicate information to other components or devices via a wireline or wireless communication connection or channel.

The content management component 600 also can include an interface component 604 that can comprise one or more interfaces, including one or more controls, switches, adapters, connectors, buttons, routers, speakers, display screens, GUIs, and/or touch screen GUIs, etc., that can facilitate enabling the content management component 600 to interface and/or communicate with other systems, components, or devices, such as, for example, communication devices (e.g., first communication device, second communication device, computing device, etc.) and/or a communication network(s).

In some implementations, the content management component 600 can comprise an aggregator component 606 that can aggregate data received (e.g., obtained) from various entities (e.g., communication device, web site, blog, communication network, etc.). The aggregator component 606 can correlate respective items of data (e.g., display characteristics, metadata, information relating to modifications to content, etc.) based at least in part on type of data, source of the data, time or date the data was generated or received, encoding state of the data, a video frame to which the data relates, etc., to facilitate analyzing the data.

In still other implementations, the content management component 600 can include an analyzer component 608 that can analyze or parse information, including information relating to display characteristics of respective communication devices, modifications made to content (e.g., in relation to presentation on a first communication device), etc., to facilitate enabling the content management component 600 to control modification and presentation of content in a uniform or substantially uniform manner across different devices having different display characteristics. The analyzer component 608 can employ (e.g., apply) one or more predefined display rules, which can be based at least in part on predefined display criterion, or one or more algorithms to the information to generate analysis results that can be used to enable the content management component 600 to make determinations regarding modifications to be made to content in relation to displaying the content on a particular communication device having particular display characteristics.

In another aspect, the content management component 600 can include a selector component 610 that can be employed to select items of information, display parameters, display characteristics, information relating to modifications to content, etc., in relation to controlling modification of content to facilitate enabling the content management component 600 to control modification and presentation of content in a uniform or substantially uniform manner across different devices having different display characteristics. For example, the selector component 610 can select a subset of display characteristics associated with a communication device to facilitate modifying content for display on the communication device, in accordance with the subset of display characteristics. As another example, the selector component 610 can select items of data (e.g., digital media data relating to image content, display characteristics of a communication device), an applicable algorithm (e.g., algorithm for use in modifying content based at least in part on display characteristics of a communication device), and/or other information, to utilize the applicable algorithm to facilitate modifying all or a subset of the items of data to modify content for display on a communication device, in accordance with the display characteristics of the communication device.

The content management component 600 also can contain an identification component 612, which can operate in conjunction with the analyzer component 608, to identify one or more objects in image content (e.g., avatar, profile picture, etc.). For instance, the identification component 612 and/or analyzer component 608 can identify the contour or features of an object (e.g., person's face or other body part, item in the background of a picture, etc.) in image content and/or location of the object in relation to other objects in the image content or in relation to an image display frame to facilitate controlling modification of image content for display on various different types of communication devices. The identification component 612 and/or analyzer component 608 can use one or more object recognition or detection algorithms to facilitate detecting, recognizing and/or identifying objects in image content.

In accordance with various aspects, the content management component 600 can contain a modification component 614 that can modify image content to generate modified image content for desired (e.g., proper) display on a communication device based at least in part on the analysis results from the analyzer component 608. For instance, the modification component 614 can modify image content in accordance with the display characteristics of the communication device (e.g., in relation to the display characteristics of the other communication device originally associated with the image content) so that the modified image content can be displayed on the communication device (e.g., second communication device) in a form that is the same or substantially the same as the form in which the image content is displayed by the other communication device (e.g., first communication device) originally associated with the image content.

In yet another aspect, the content management component 600 can comprise a processor component 616 that can work in conjunction with the other components (e.g., communicator component 602, interface component 604, aggregator component 606, etc.) to facilitate performing the various functions of the content management component 600. The processor component 616 can employ one or more processors, microprocessors, or controllers that can process data, such as information relating to modifying content, analyzing content, identifying objects contained in content, display characteristics respectively associated with different communication devices, predefined display criteria, an algorithm(s), operations of the content management component 600, and/or other information, etc., to facilitate operation of the content management component 600, as more fully disclosed herein, and control data flow between the content management component 600 and other components (e.g., communication device, communication network, etc.) associated with the content management component 600.

The content management component 600 also can include a data store 618 that can store data structures (e.g., user data, metadata), code structure(s) (e.g., modules, objects, hashes, classes, procedures) or instructions, information relating to modifying content, analyzing content, identifying objects contained in content, display characteristics respectively associated with different communication devices, predefined display criteria, an algorithm(s), operations of the content management component 600, and/or other information, to facilitate controlling operations associated with the content management component 600. In an aspect, the processor component 616 can be functionally coupled (e.g., through a memory bus) to the data store 618 in order to store and retrieve information desired to operate and/or confer functionality, at least in part, to the communicator component 602, interface component 604, aggregator component 606, etc., and/or substantially any other operational aspects of the content management component 600.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

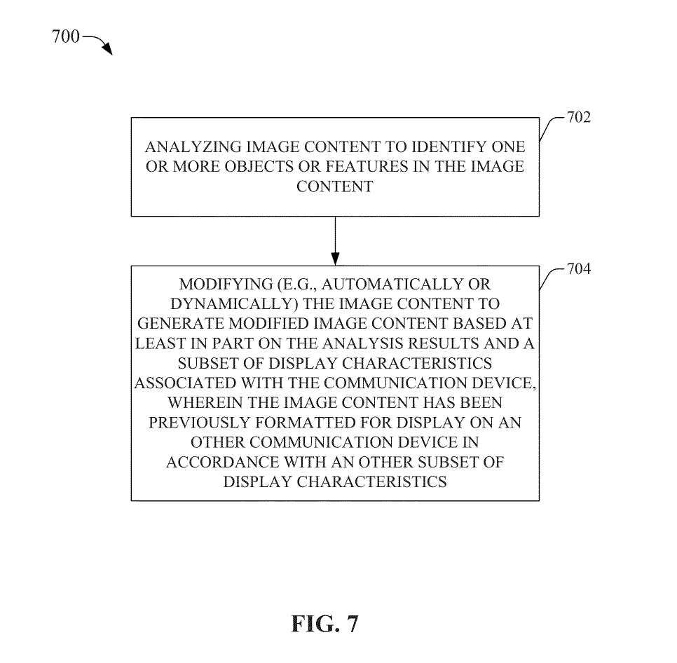

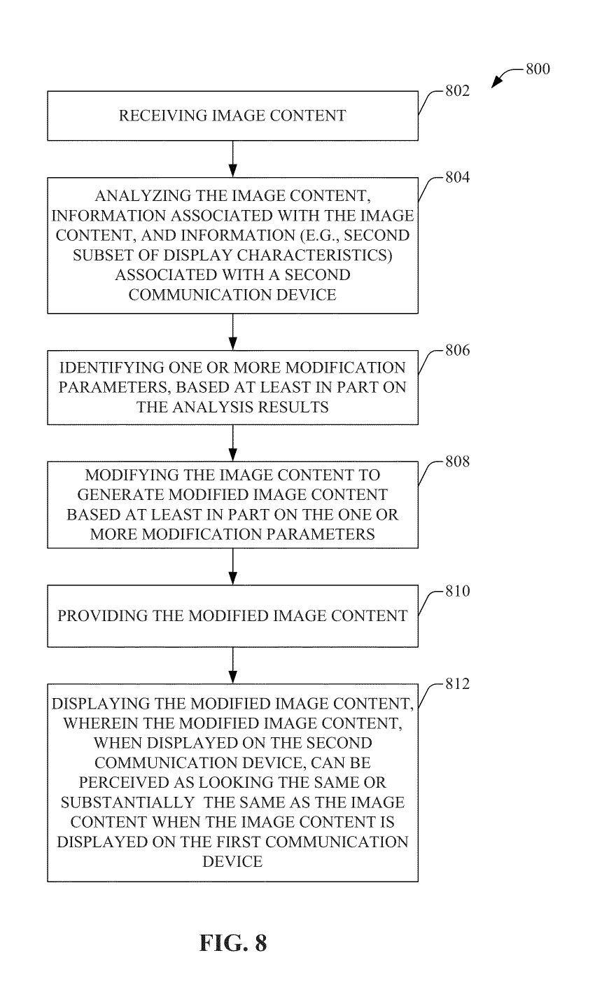

In view of the example systems described above, example methods that can be implemented in accordance with the disclosed subject matter can be better appreciated with reference to flowcharts in FIGS. 7-8. For purposes of simplicity of explanation, various methods disclosed herein are presented and described as a series of acts; however, it is to be understood and appreciated that the subject disclosure is not limited by the order of acts, as some acts may occur in different order and/or concurrently with other acts from that shown and described herein. It is noted that not all illustrated acts may be required to implement a described method in accordance with the subject specification. In addition, for example, one or more methods disclosed herein could alternatively be represented as a series of interrelated states or events, such as in a state diagram. Moreover, interaction diagram(s) or call flow(s) represent several of the example methods disclosed herein in accordance with the described subject matter; particularly in instances when disparate entities, or functional elements, enact disparate portions of one or more of the several methods. Furthermore, two or more of the disclosed example methods can be implemented in combination, to accomplish one or more features or advantages described in the subject disclosure.

With reference to FIG. 7, illustrated is a flow chart of an example method 700 for controlling modification of image content based at least in part on display characteristics of a communication device, in accordance with various aspects and embodiments. At 702, image content can be analyzed (e.g., by a content management component) to identify one or more objects or features in the image content. The image content can be, for example, content originally formatted for display in accordance with a first subset of display characteristics of a first communication device and/or display parameter settings (e.g., display parameter settings relating to cropping, scaling, orientation, etc., of the image content) to facilitate displaying the image content on the first communication device as desired by, for example, a user of the first communication device.

In some implementations, the content management component can analyze the image content to identify objects or features (e.g., object edges or contours, face or other body parts, etc.) contained in the image content. For example, the content management component can detect and/or identify (e.g., automatically or dynamically) the contours (e.g., shape, edge(s), etc.) of an object(s) in the image content and the location of the object(s) in relation to other objects in the image content or in relation to a display image frame in which the image content is displayed.

At 704, the image content of the image can be modified (e.g., automatically or dynamically) to generate modified image content based at least in part on the analysis results and a subset (e.g., second subset) of display characteristics associated with the communication device. In some implementations, the content management component can modify the image content such that the modified image content can be displayed on the second communication device in accordance with the second subset of display characteristics, so that, on the second communication device, the modified image content appears to look the same or substantially as the image content looks when displayed on the first communication device.

Referring next to FIG. 8, depicted is a flow chart of another example a method 800 for controlling modification of image content based at least in part on display characteristics of a communication device, in accordance with various aspects and embodiments. At 802, image content can be received, for example, by a content management component. The image content can be content that was previously formatted for viewing on a first communication device, based at least in part on a first subset of display characteristics associated with the first communication device. The content management component can receive the image content in relation to displaying the image content, or modifying the image content for displaying of modified image content, on a second communication device in accordance with a second subset of display characteristics associated with the second communication device.

At 804, the image content, information associated with the image content, and information (e.g., second subset of display characteristics) associated with a second communication device can be analyzed. The content management component can analyze the image content to identify an object(s) or feature(s) contained in the image content, as more fully disclosed herein.

The content management component also can analyze information associated with the image content, such as, for example, formatting or prior modification information (e.g., cropping, scaling, orientation adjustments, etc.) associated with the image content, the first subset of display characteristics associated with the first communication device, current display characteristics (e.g., size, orientation, resolution, framing, etc.) associated with the image content, other metadata associated with the image content, etc. The content management component also can analyze the second subset of display characteristics associated with the second communication device. The content management component can generate analysis results based at least in part on the analysis of these various pieces of information.

At 806, one or more modification parameters can be identified, based at least in part on the analysis results. The content management component can identify one or more modification parameters that can be used to modify the image content to generate modified image content in accordance with the second subset of display characteristics. The one or more modification parameters can relate to, for example, modification of the size of the image content, resolution of the image content, cropping of the image content, orientation of the image content, framing of the image content, etc.

At 808, the image content can be modified to generate modified image content based at least in part on the one or more modification parameters. The content management component can use (e.g., apply and/or set) the one or more modification parameters to modify the image content to generate the modified image content. At 810, the image content can be provided (e.g., transmitted). In some implementations, the content management component can be a stand-alone component or can be located in a computing device (e.g., a server) that provides content, and can transmit the modified image content to the second communication device to facilitate display of the modified image content on the second communication device. In other implementations, the content management component can be part of the second communication device and can output the modified image content to facilitate display of the modified image content on the display component (e.g., second display component) of the second communication device. At 812, the modified image content can be displayed (e.g., on the second display component), wherein the modified image content, when displayed on the second display component (e.g., of the second communication device), can be perceived as looking the same or substantially the same as the image content when the image content is displayed on the first display component (e.g., of the first communication device).

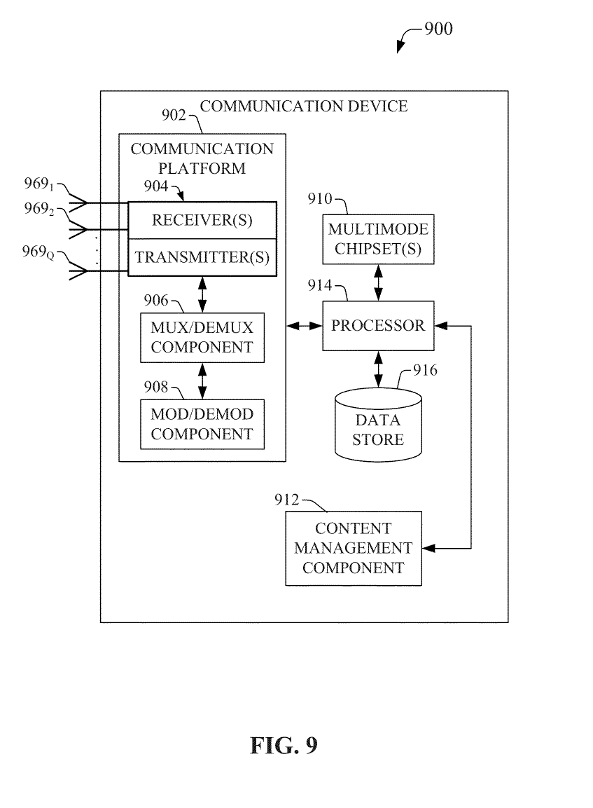

FIG. 9 depicts a block diagram of an example wireless communication device 900 in accordance with various aspects and embodiments of the disclosed subject matter. In an aspect, the communication device 900 can be a multimode access terminal, wherein a set of antennas 969₁-969_{Q} (Q is a positive integer) can receive and transmit signal(s) from and to wireless devices like access points, access terminals, wireless ports and routers, and so forth, that operate in a radio access network. It should be appreciated that antennas 969₁-969_{Q} are a part of communication platform 902, which comprises electronic components and associated circuitry that provide for processing and manipulation of received signal(s) and signal(s) to be transmitted; e.g., receivers and transmitters 904, multiplexer/demultiplexer (mux/demux) component 906, and modulation/demodulation (mod/demod) component 908.

In another aspect, the communication device 900 can include a multimode operation chipset(s) 910 that can allow the communication device 900 to operate in multiple communication modes in accordance with disparate technical specification for wireless technologies. In an aspect, multimode operation chipset(s) 910 can utilize communication platform 902 in accordance with a specific mode of operation (e.g., voice, GPS). In another aspect, multimode operation chipset(s) 910 can be scheduled to operate concurrently (e.g., when Q>1) in various modes or within a multitask paradigm.

In some embodiments, the communication device 900 can comprise a content management component 912 that can automatically and/or dynamically control generation, modification and/or display of image content so that the image content can be displayed so that the image content can be perceived to be the same or substantially the same across different communication devices, in accordance with predefined display criterion, as more fully disclosed herein. The content management component 912 can thereby facilitate uniform or substantially uniform display of content across different display components having different display characteristics.

In still another aspect, the communication device 900 also can include a processor(s) 914 that can be configured to confer functionality, at least in part, to substantially any electronic component within the communication device 900, in accordance with aspects of the disclosed subject matter. For example, the processor(s) 914 can facilitate enabling the communication device 900 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. In some implementations, the processor(s) 914 can process data relating to modifying content, analyzing content, identifying objects contained in content, display characteristics associated with the communication device 900 or other communication devices, predefined display criteria, an algorithm(s), etc.

The communication device 900 also can contain a data store 916 that can store data structures (e.g., user data, metadata); code structure(s) (e.g., modules, objects, classes, procedures) or instructions; message hashes; information relating to modifying content, analyzing content, identifying objects contained in content, display characteristics associated with the communication device 900 or other communication devices, predefined display criteria, an algorithm(s), etc., and/or other data processes relating to modifying content, analyzing content, identifying objects contained in content, displaying content, etc.; network or device information like policies and specifications; attachment protocols; code sequences for scrambling, spreading and pilot (e.g., reference signal(s)) transmission; frequency offsets; cell IDs; encoding algorithms; compression algorithms; decoding algorithms; decompression algorithms; and so on. In an aspect, the processor(s) 914 can be functionally coupled (e.g., through a memory bus) to the data store 916 in order to store and retrieve information (e.g., information relating to displaying of content, voice calls, or other services; frequency offsets; desired algorithms; etc.) desired to operate and/or confer functionality, at least in part, to the communication platform 902, multimode operation chipset(s) 910, content management component 912, and/or substantially any other operational aspects of the communication device 900.

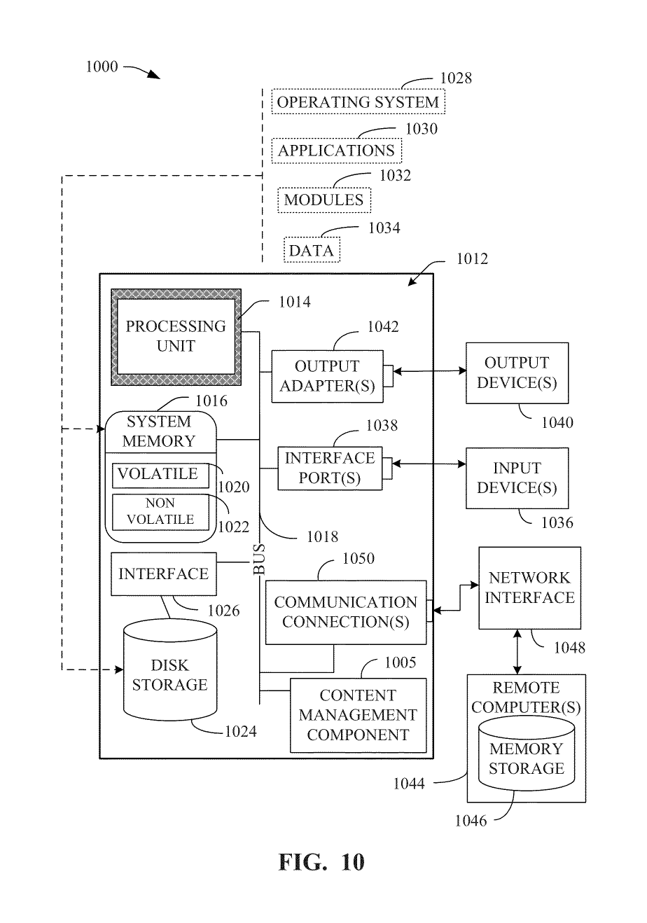

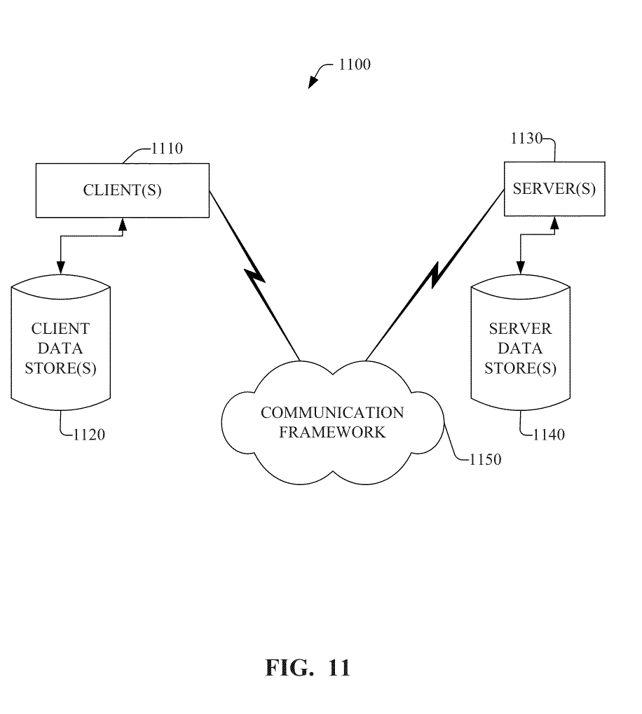

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the disclosed subject matter also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of the disclosed subject matter can be practiced on stand-alone computers. In a distributed computing environment, program modules may be located in both local and remote memory storage devices.

With reference to FIG. 10, a suitable environment 1000 for implementing various aspects of the disclosed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example, a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used, such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

In some embodiments, the computer 1012 can comprise a content management component 1005. The content management component 1005 can be used to manage generation, modification and/or display of content (e.g., image content, such as avatars, profile pictures, etc.) on a display component associated with the computer 1012 or associated with another communication device, as more fully disclosed herein.

FIG. 11 is a schematic block diagram of a sample-computing environment 1100 with which the subject specification can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing the disclosed subject matter, for example. One possible communication between a client 1110 and a server 1130 may be in the form of a data packet transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1120 that can be employed to store information local to the client(s) 1110. Similarly, the server(s) 1130 are operatively connected to one or more server data store(s) 1140 that can be employed to store information local to the servers 1130.

It is to be appreciated and understood that components (e.g., communication device, communication network, content management component, computing device, server, computer, etc.), as described with regard to a particular system or method, can include the same or similar functionality as respective components (e.g., respectively named components or similarly named components) as described with regard to other systems or methods disclosed herein.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “mobile station,” “mobile,” “wireless device,” “wireless communication device,” “access terminal,” “terminal,” and similar terminology are used herein to refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the term “access point” (AP), can be or can comprise a base station, Node B, Evolved Node B (eNode B or eNB), Home Node B (HNB), home access point (HAP), and can refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be noted that aspects, features, and/or advantages of the disclosed subject matter can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as IPTV, etc.) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a communication device configured to display content; and
a content management component associated with the communication device and configured to control modification of the content to generate modified content in accordance with a subset of display characteristics associated with the communication device, wherein the content was previously formatted for display on an other communication device in accordance with an other subset of display characteristics.

2. The system of claim 1, wherein the content is image content, comprising at least one of an avatar or a profile picture.

3. The system of claim 2, wherein the image content is animated content comprising a plurality of digital images.

4. The system of claim 1, wherein the content management component is further configured to analyze at least one of the content, the subset of display characteristics, the other subset of display characteristics, current display characteristics associated with the content, prior modification information associated with the content, or metadata associated with the content, to generate analysis results.

5. The system of claim 4, wherein the content management component is further configured to identify one or more contours or features of an object in the content.

6. The system of claim 4, wherein the content management component is further configured to identify at least one of size of the content or resolution of the content.

7. The system of claim 4, wherein the prior modification information comprises information relating to at least one of adjustment to size of the content, cropping of the content, adjustment to orientation of the content, or adjustment to framing of the content within an image display frame.

8. The system of claim 4, wherein the content management component is further configured to identify at least one difference between the subset of display characteristics and at least one of the other subset of display characteristics or the current display characteristics associated with the content, based at least in part on the analysis results.

9. The system of claim 8, wherein the content management component is further configured to modify the content to generate the modified content, based at least in part on the at least one difference between the subset of display characteristics and the at least one of the other subset of display characteristics or the current display characteristics associated with the content.

10. The system of claim 1, wherein the content management component is further configured to provide the modified content for display on the communication device, wherein the modified content as displayed on the communication device corresponds to display of the content on the other communication device.

11. The system of claim 1, wherein the communication device comprises the content management component.

12. The system of claim 1, further comprising a computing device configured to provide content, wherein the computing device includes the content management component.

13. The system of claim 12, wherein the content management component is further configured to transmit a query to the communication device, wherein the query requests information relating to the subset of display characteristics from the communication device.

14. A system, comprising:
a communication device configured to display content comprising an avatar; and
a content management component associated with the communication device and configured to control modification of the avatar to generate a modified avatar in accordance with a subset of display characteristics associated with the communication device, wherein the avatar was previously formatted for display on an other communication device in accordance with an other subset of display characteristics.

15. The system of claim 14, wherein the content management component is further configured to identify one or more contours or features of an object in the avatar.

16. The system of claim 15, wherein the object is a digital representation of at least a portion of a body of a person, and wherein the content management component is further configured to identify the contours of the portion of the body of the person in the avatar.

17. The system of claim 16, wherein the content management component is further configured to modify the avatar to generate the modified avatar based at least in part on the contours of the portion of the body of the person identified in the avatar and the subset of display characteristics associated with the communication device.

18. The system of claim 17, wherein the portion of the body of the person comprises a face of the person, and wherein the content management component is further configured to adjust display of the face of the person in the modified avatar to have the face of the person displayed on the communication device to correspond to the display of the face of the person on the other communication device.

19. A method, comprising:
employing at least one processor to facilitate execution of code instructions retained in at least one memory, the code instructions, in response to execution, perform acts comprising:
analyzing information associated with image content and a subset of display characteristics associated with a communication device to generate analysis results that facilitate modifying the image content; and
controlling modifying the image content to generate modified image content in accordance with the subset of display characteristics, wherein the image content has been previously formatted for display on an other communication device in accordance with an other subset of display characteristics.

20. The method of claim 19, further comprising:
modifying the image content to generate the modified image content for display on the communication device, wherein the modified image content as displayed on the communication device is perceived as appearing to be same or at least substantially the same as the image content when the image content is displayed on the other communication device.

21. The method of claim 19, further comprising:
analyzing at least one of the image content, the subset of display characteristics, the other subset of display characteristics, current display characteristics associated with the image content, prior modification information associated with the image content, or metadata associated with the image content; and
generating the analysis results.

22. The method of claim 21, further comprising:
modifying the image content to generate the modified image content, based at least in part on at least one difference between the subset of display characteristics and at least one of the other subset of display characteristics or the current display characteristics associated with the content.

23. The method of claim 21, further comprising identifying prior modification of the image content based at least in part on the prior modification information, wherein the prior modification information comprises information relating to at least one of adjustment to size of the image content, cropping of the image content, adjustment to orientation of the image content, or adjustment to framing of the image content within an image display frame.

24. The method of claim 23, further comprising:
at least one of:
transmitting a first type of query to the communication device, wherein the first type of query requests information relating to the subset of display characteristics from the communication device, wherein the first type of query is transmitted from a computing device; or
transmitting a second type of query to the computing device, wherein the second type of query requests information relating to at least one of the other subset of display characteristics, the current display characteristics associated with the image content, the prior modification information associated with the image content, or the metadata associated with the image content, from the computing device, wherein the second type of query is transmitted from the communication device.

25. The method of claim 19, further comprising identifying one or more contours or features of an object in the image content.

26. The method of claim 19, further comprising identifying at least one of size of the image content or resolution of the image content.

27. A computer program product comprising a computer readable storage medium having computer executable instructions stored thereon that, in response to execution, cause a computing system to perform operations, comprising:
analyzing information associated with content and a subset of display characteristics associated with a communication device to generate analysis results that facilitate modifying the content; and
managing modifying the content to generate modified content in accordance with the subset of display characteristics, wherein the content has been previously formatted for display on an other communication device in accordance with an other subset of display characteristics.
